(19) United States
(12) Patent Application Publication
(10) Pub. No.: US 2022/0366244 A1
(43) Pub. Date: Nov. 17, 2022

(54) Modeling Human Behavior in Work Environment Using Neural Networks

(71) Applicant: Siemens Aktiengesellschaft, Munich (DE)

(72) Inventors: Jason Vandeventer, Charlotte, NC (US); Arquimedes Martinez Canedo, Plainsboro, NJ (US); Mayuri Deshpande, Charlotte, NC (US)

(21) Appl. No.: 17/761,396

(22) PCT Filed: Sep. 30, 2019
(86) PCT No.: PCT/US2019/053783

§ 371 Date: Mar. 17, 2022

(51) Int. Cl. G06N 3/08

(52) U.S. Cl. CPC G06N 3/08

(57) ABSTRACT

A system and method for modeling human behavior includes receiving, by a classifier module, sensor data from one or more sensors monitoring human behavior associated with a work task and to identify the type of human behavior based on a trained neural network. A prediction module receives the identified type of human behavior from the classifier and generates prediction data representing predicted next one or more human actions based on a time series of position vectors learned by the trained neural network. A rendering module translates the prediction data into a visual rendering for a virtual human simulation model.

### TECHNICAL FIELD

This application relates to digital modeling. More particularly, this application relates to a digital modeling of human behavior using neural networks.

### BACKGROUND

In manufacturing environments, there are a number of factors which affect performance of the human worker. Software systems used in the design of factory floors, assembly operations, and similar environments rely on simple, predetermined animation of digital characters in digital work environments to assess things such as safety, ergonomics, and other human factors.

There are existing simulation software tools for visual rendering virtual humans performing work tasks on virtual products in virtual environments for the purpose of ergonomic analysis. Virtual humans can be matched to various worker populations, and test product and work environment designs against human factors such as injury, risk, user comfort, reachability, line of sight, energy expenditure, and fatigue limits. Virtual humans are anthropometrically and biomechanically accurate. However, the limitation of these tools is the lack of adaptation of virtual humans to a real and current environment. Instead, existing solutions rely on pre-programmed human behavioral models that always follow the same script.

### SUMMARY

Aspects according to embodiments of the present disclosure include methods and systems which provide greater flexibility and a more natural response from virtual humans in digital modeling of human behavior. Data driven modeling may be executed by a neural network (e.g., artificial neural network, self-organizing map, etc.) to determine patterns of behaviors and decisions based on actual human behavior observed and captured by one or more sensors. Behavior of virtual humans (digital models) may be driven by the behaviors learned by the neural network. Accordingly, the virtual human behavior model may provide predictability of human behavior across a variety of environments and situations beyond scripted ones, for contexts and environments not previously observed. The model is useful to predict most likely human behavior (e.g., body positions) for a particular set of environmental and situational parameters. Predictions can be useful to lead to safer plant design, improve ergonomics and help avoid physical injury.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows a flow chart example of a process for training a neural network to produce a virtual human behavior model in accordance with embodiments of the disclosure.

FIG. 2 shows an example of human activity for representation by a virtual model in accordance with embodiments of the disclosure.

FIG. 3 shows a flow chart example of processes for operation of the virtual human behavior model in accordance with embodiments of the disclosure.

FIG. 4 shows a flow chart example of a conversion process for a virtual human rendering in accordance with embodiments of the disclosure.

FIG. 5 shows an example set of application modules for performing the human behavior modeling according to embodiments of the disclosure.

FIG. 6 shows a block diagram of a computing environment example within which embodiments of the disclosure may be implemented.

### DETAILED DESCRIPTION

Methods and apparatuses of the present disclosure provide a process of digital modeling of human behavior across various work settings. The resultant model can predict how a human will approach a work task in terms of various physical positions, which may lead to the following advantages. Enhanced design of plant setup can be optimized for safety and ergonomics. Possible damage to equipment (e.g., human exerting forces on weak points of equipment) can be better predicted. Physical human modeling can be generated based on different human body physiques, such as variations in height and girth, for improved prediction of potential human injury for a given work setting and/or task. The virtual model can have a broad range of environmental and situational parameters such that prediction of human behavior for a simulation of a proposed setting can have a strong likelihood of success. Human factor parameters are also included for the modeling, which can provide additional support for predicting what drives a human to behave a particular way for both universal behavior and locally influenced behavior, if any (e.g., behavioral particularities based on cultural background and anatomical ratio parameters across the human spectrum which may have prevalence within particular geographic regions—North America, South America, Asia, etc.). For example, training a machine learning model (e.g., a neural network) for a localized work environment can provide a customized model useful for accurately predicting how local workers will behave in a particular work facility. Using machine learning models to process the observations, the derived model can be agnostic to whether the behavior is influenced either by psychological or physiological factors, as the model relies on learning by a multitude of observed outcomes. The derived model can predict subsequent human actions based on previously observed actions by running in parallel with real time activity with common sensors (i.e., run the model as a digital twin to the real world) and comparing current state of real world to the model.

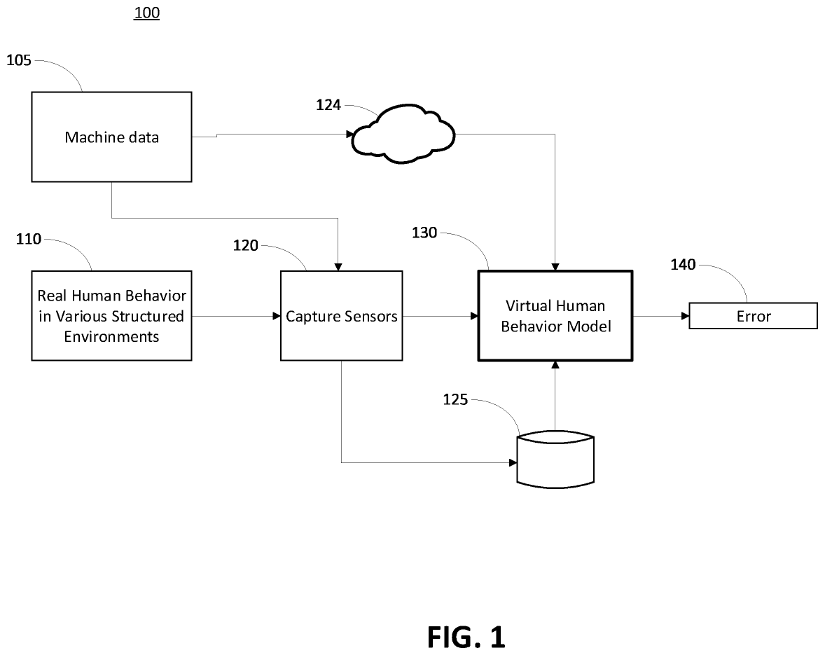

FIG. 1 shows a flow chart example of a process for training a virtual human behavior model in accordance with embodiments of the disclosure. Process 100 includes virtual human behavior model 130 receiving training inputs from capture sensors 120 for a data driven behavior modeling. Activity 110 may include various real human behavior within various environments to be observed by capture sensor 120. Aspects of the human behavior model 130 include implementation as a neural network (e.g., an artificial neural network (ANN)), a self-organizing map, or some variation thereof. The human behavior model 130 may be trained as a classifier by supervised training using annotated training data received from cloud based archives 124 or local data store 125 to generate classifications, which are checked against the annotation labels to produce error 140. As error rate is reduced to a threshold tolerance limit, the training of the virtual human behavior model 130 is deemed completed.

In an aspect, the virtual human behavior model 130 may be trained to infer a predicted next body position and velocity. As training data for such an objective, each training image may be labeled to include annotated skeleton markers on a human subject being observed and encoded 3D locations in space, along with velocity vectors. For example, training data can be produced using motion capture (“mo-cap”) techniques, using capture sensor 120 configured for such inputs (e.g., cameras that generate labeled images annotated with encoded 3D location of a camera relative to the subject). During the training process 100, the virtual human behavior model 130 learns ground truth/labels in relation to an input image. Following training process 100, the virtual human behavior model 130 could then be applied in a runtime mode to process real time images (e.g., as snapshots of captured video) of human behavior, and produce classifier output with information related to expected next body position and velocity, which will be described later in greater detail.

Capture sensors 120 may be one or more of RGB cameras, depth-sensing cameras (e.g., 2.5D, 3D, 4D), infrared cameras, multi-spectral imaging, and similar sensors. Inputs 110 to the capture sensors 120 may include observed actions by real humans within environments, such as a factory or a production setting while interacting with the physical world, including a work product and/or production equipment. In an embodiment, training process 100 can be executed for a particular work facility in the design stage to optimize the layout for safety, ergonomic and productivity factors. The objective for the capture sensors 120 is to be positioned in various aspects with respect to the scene in order to accumulate training data stored in database 125. Over time, observations can be varied across various situations of operation and interaction of real humans in different settings and with different work products.

The trained virtual human behavior model 130 may be configured as a classifier to identify situation and environment parameters as well as related human behaviors responsive to particular tasks in the respective work situation and environment. During the training process 100, the neural network or other machine learning model may receive the training data to reinforce parameters that relate to predicting actions as human behavior. There are many examples of human behavior states that may not be accurately modeled by conventional programming methods which rely on making pre-determined choices applied to every similar situation. For example, such behavior states may include how a human responds to a dropped item, which is based on his experience and external real time factors (e.g., motion, speed, direction, etc.). Also, a human can exhibit complex behavior patterns to similar situations depending upon dynamics of a situation, and behavior may evolve based on experience in handling such dynamic situations. Since programmers primarily are forced to model a virtual human based on pre-determined choices applied to similar situations, the disclosed process 100 expands virtual human modeling using data-driven learning across an expanded set of situational parameters, beyond what a programmer would be capable of accounting for. Unlike the human programmer who may overlook parameters (e.g., the effects of time of day on human actions and choices), the virtual human behavior model 130 considers all available situational parameters in conjunction with learned human behaviors over many trials of observations (e.g., thousands of trials). For example, capture sensors may capture human actions, gestures, manifested emotions, dyadic interactions with fellow teammates, among other possible human responses, for robust modeling of action decisions and behaviors.

In an embodiment, the training process 100 may include capturing one or more live feeds of sensor data (e.g., an image of a human activity in a particular task within a particular setting) from sensors 120, while comparing to a previous sample image (e.g., a labeled image) of a similar event recorded previously and saved to database 125. Alternatively, or additionally, training inputs may be still images, video clips, or other data fed from stores of data, such as cloud-based data 124, related to the task of interest. The machine learning may extract human activity for the given task, situation, and environment for each training trial.

The training process 100 includes many iterations of inputs being processed by layers of the neural network until there is convergence, marking the conclusion of the training. For example, a loss function layer for a neural network embodiment may compare classification outputs to a ground truth value to compute an error. An error rate of many trials can be computed as a trend or average, which can eventually drop below a predetermined tolerance value as the machine learning by the model is reached. An optimal virtual human behavior model 130 is generated in which variability of human behavior is predicted with a high rate of success. A first step to achieve the optimal model 130 is by including a high variability of the training data. Additionally, the model 130 is further optimized by continual learning by the neural network when errors are detected during the later prediction phase of operation, and the neural network may then be retrained with supplemented training data to address the types of human subjects, the environmental parameters, the situational parameters or some combination thereof, related to the yielded errors.

In an aspect, training of virtual human behavior model 130 may include training data to derive a situational awareness driven model by annotating predicted situations based on similarity of complexity and dynamics between known and unknown situations. The training data for such a model can be extracted from vast amounts of machine data 105 produced on the factory floor and captured by various sensors 120, such as machine states and environmental conditions measured periodically, and stored in data storage 125 (e.g., one or more data historians in an automated production factory). Machine data 105 may also be received by virtual human behavior model 130 via network 124 (e.g., via embedded systems of a factory process control network). The advantage of a situational awareness driven model is to avoid prediction failure upon observing a completely unanticipated situation, relying on comprehensive understanding of the human behavior for various situations and environmental conditions gained from machine learning using the collected machine data 105. For example, later during a real time prediction operation the system controller 101 after training is completed, unanticipated situations may be captured by sensors 120 and the virtual human behavior model 130 is able to use inferencing to predict a behavior state.

In an embodiment, virtual human behavior model 130 is a representation of a state for the neurons of a trained neural network (e.g., parameter weights) once the convergence of the training is achieved. The model 130 may represent different human body positions in a time sequence, which can be classified as different activities. Transitions during the time sequence are observed for patterns. For example, the model 130 may include a set of time sequence vectors Vₜ for time t=T₁, T₂, T₃ . . . T_{N} with a number of vector dimensions to describe the subject human body, the environment and the aspects of the situational task to be modeled. In an embodiment, a model 130 may represent a state human behavior, such as a state of walking. As a variation, a model 130 may represent a group related states, such as upper body movements and head movements. Accordingly, three sub-models could each represent a variety of states as follows.
Model 130a: Walking, jogging, running
Model 130b: Sitting, squatting, kneeling, rising, leaning
Model 130c: Upper body movements, head movements
   Accordingly, each sub-model 130a, 130b, 130c, can be learned during training and used in an additive manner to construct a sequence of human behavior sequences, using simpler movements in combination to form a complex movement. In an aspect, the variety of states may include both captured performances via sensors, as well as states interpolated and extrapolated by inference functionality of the model 130. Transitions between the various states (e.g., such as temporal dynamics) can be embedded in the model 130. With this approach, a comprehensive set of activities can be stitched to construct a sequence of movements with smooth transitions to more closely resemble natural human motion instead of appearing stuttered or jerky.

In an embodiment, an ANN may be trained as the virtual human behavior model 130 by training process 100 to learn the various human body positions and transitions during work tasks. In another embodiment, a recurrent neural network (RNN) can be trained as the human behavior model 130 using annotated time sequenced images to mine for temporal patterns in the data. Once trained, the RNN will be capable of classifying observed activity in real time as well as providing a prediction for the next state of the human subject. In an aspect of ANN or RNN implementations, where training data consists of mixed data sets as training data, such as 2D RGB images and 3D representations, model 130 may include an image converter to convert 2D images into 3D representations for compatible correlations with the other 3D data, allowing simulated environment physics and collision conditions more accurately.

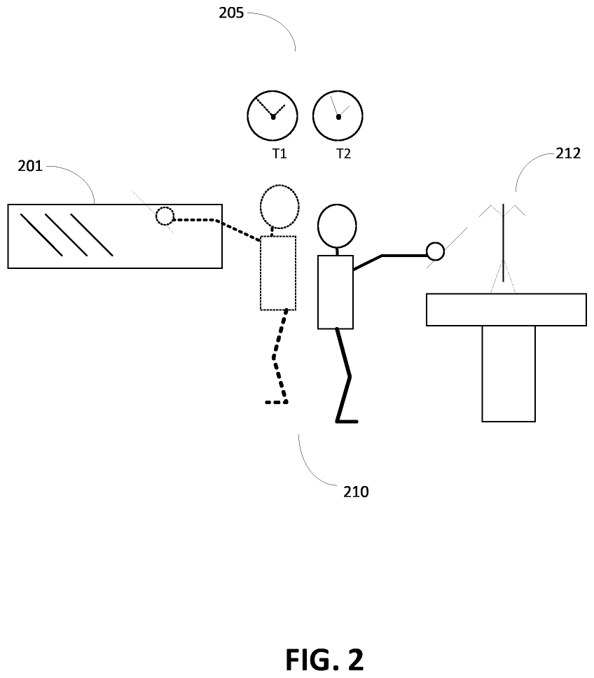

FIG. 2 shows an example of human activity for representation by a virtual model in accordance with embodiments of the disclosure. Human body positions 210 are observed and captured over a time span 205 for time instances T₁, T₂ in a work environment 201, while performing a work task of assembling a work product 212. For this example, vectors may be generated as follows:

V_{T1}[a1,a2,a3,b1,b2,c1,c2,c3,d1,d2,d3,e1,f1,f2,g1,h1 . . . N]

V_{T2}[a1,a2,a3,b1,b2,c1,c2,c3,d1,d2,d3,e1,f1,f2,g1,h1 . . . N]

where

a1, a2, a3=head position

b1, b2=torso position

c1, c2, c3=hand position

d1, d2, d3=knee position

e1, e2, e3=foot position

f1, f2, =environmental parameters

g1=situation parameter

h1 . . . N=other parameters

The above vector parameters and variables are a sample of many possible mapping points for a work task, and do not represent the full scope of elements for the human behavior model embodiments of this disclosure. As more time sequences are observed by capture sensors 120, additional vectors are accumulated up to vector V_{TN}. Optimized training includes various human subjects of different gender, size, and level of experience for the monitored work task. Data fields for gender, body size (e.g., height, weight) and experience may be added to vector V, or may be recorded in a separate vector and linked to vector V in data store 125. In an embodiment, the training may include observations of work production and ergonomic measures according to predetermined baseline data relative to the various human positions recorded by each vector V.

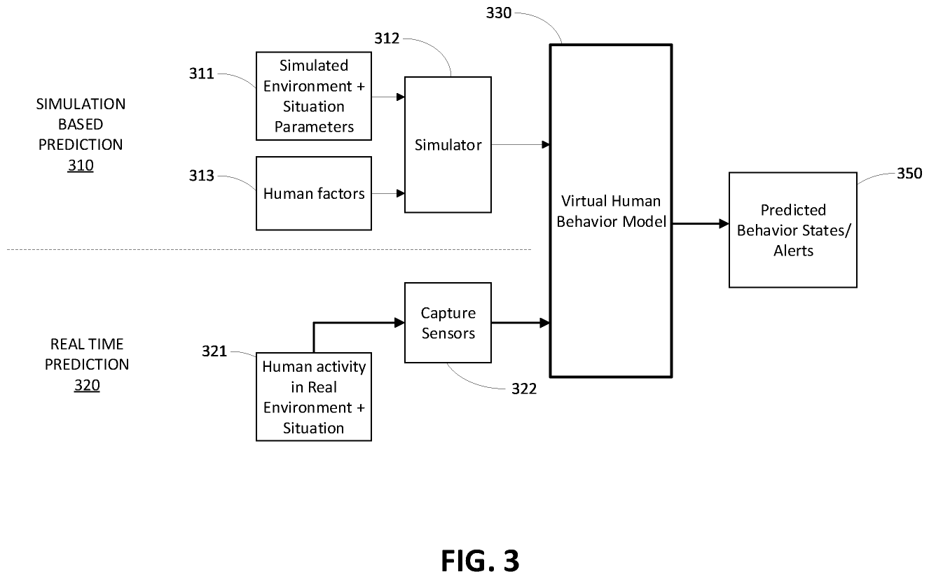

FIG. 3 shows a flow chart example of processes for operation of the virtual human behavior model in accordance with embodiments of the disclosure. In an embodiment, a simulation based prediction 310 of human activity can be fed as input to the virtual human behavior model 330 as an on-demand query by a user to request predicted behavior states 350 given a set of environmental and situation parameters 311 with a range of human factors 313 for a subject human operator (e.g., physical characteristics, skills, etc.). In an embodiment, a simulator 312 synthesizes images of a virtual human in a simulated environment. Inputs for a simulation based prediction query include environment and situation parameters 310 and human factors 311, from which simulator 312 generates simulated images as input to the virtual human behavior model 330. After processing the simulation inputs, the virtual human behavior model 330 generates predicted behavior states 350. In embodiment, the predicted behavior states 350 are ranked according to optimal work production, work safety, ergonomic score, or a combination thereof, generated during the training phase. Further analysis can be performed on the work production, work safety, and ergonomic scores to develop optimized work station configuration and/or plant setup.

In another embodiment, a real time prediction 320 mode for the virtual human behavior model 330 involves observing human activity 321 in a real environment with a task situation via capture sensors 322 to generate predicted behavior states 350. For example, the capture sensors 322 may be capturing live images of an actual human worker performing an assembly task on a table work station in a production factory setting. The virtual human behavior model 330 may identify the human behavior state and classify a predicted behavior state based on learned transition patterns. The prediction states 350 may be in the form of human position vectors for one or more time instances. On a condition that prediction data 350 indicates that a next one or more human actions is likely to cause a human injury based on previously observed injury events, an alert signal (e.g., a visual notification or audio alarm) may be sent as a warning to the human worker being monitored. Likewise, on condition that the prediction data 350 indicates that work equipment is at risk of damage (e.g., based on learned weak points of the work equipment learned during training of the neural network), an alert signal may be sent as a warning.

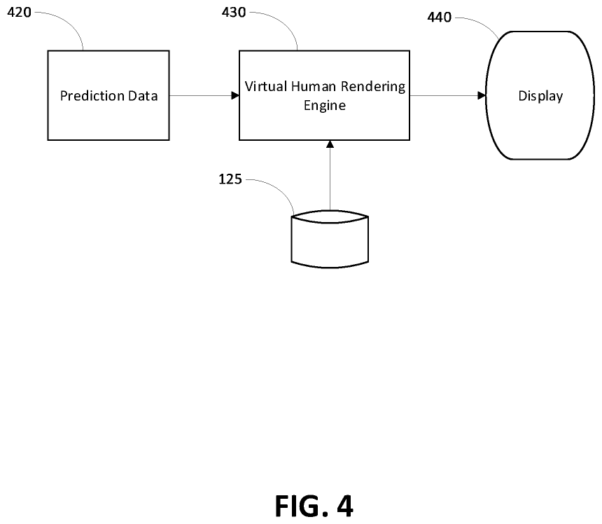

FIG. 4 shows a flow chart example of a conversion process for a virtual human rendering in accordance with embodiments of the disclosure. The prediction data 420 may include predicted states 350 of human activity as floating point vector data of predicted human behavior. Virtual human rendering engine 430 receives the prediction data 420 and translates a selected candidate of the vectorized human position data into a visual rendering of a virtual human simulation, which can be viewed on display 440. In an embodiment, virtual human rendering engine extracts knowledge (e.g., images) from data store 125 having visual data obtained from capture sensors 120 and maps human position vectors of prediction data 420 to resembling images according to a matching algorithm. Initial renderings can be morphed with the matching images for an enhanced visual rendering of the predicted human behavior. The visual rendering may be sent to a display device 440 as an animation of a virtual human for viewing by an operator in response to a query for predicted human behavior. The translation of the predicted data may include a time series sequence of predicted human actions for simulating a video segment, or a single instance (snapshot) of human action for simulating a still image.

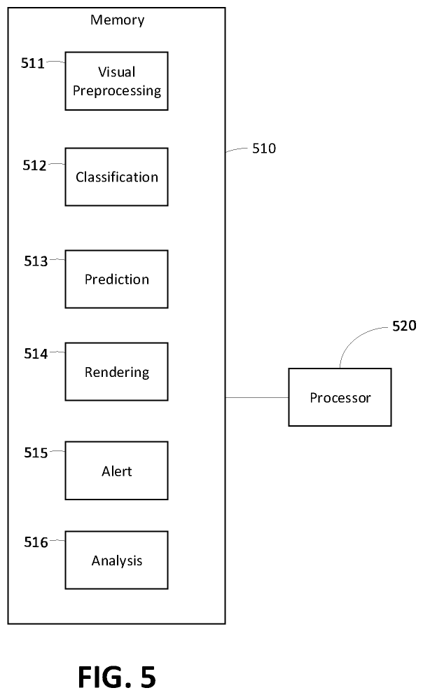

FIG. 5 shows an example set of application modules for performing the human behavior modeling according to embodiments of the disclosure. A processor 520 may execute various application modules 510 during the training and operation of the machine learning model (e.g., neural network) for human behavior modeling. Visual preprocessing module 511 may include program instructions for preprocessing sensor data, such as video capture, RGB capture, depth sensor readings, and the like, to translate the information into a uniform code useable by the input layer of the neural network or other machine learning based model network. Classification module 512 may include program instructions for operating the neural network during classification tasks, such as during the training phase or during runtime phase. Prediction module 513 may include program instructions for operating the trained neural network during prediction tasks, such as handling queries for a prediction and directing the input data and output data. Rendering module 514 may include program instructions for the virtual human rendering engine 430, translating the prediction data into a visual rendering for a virtual human simulation model. In an embodiment, the program instructions may directly translate the prediction data according to a standard mapping of human body position data. Alternatively, the prediction data may be mapped to stored knowledge data of human actions and the visual rendering may be extracted from the knowledge base according to the closest match. Alert module 515 is configured to monitor the prediction data and send an alert signal in response to a determination that a next one or more human actions is likely to produce a human injury or damage to work equipment. Analysis module 516 is configured to rank predicted behavior states 350 of work production, work safety, ergonomic scores, or a combination thereof. Analysis module 516 may use the trained neural network tuned to simulated environment and situation parameters so that parameter weights correspond to a new problem having a proposed environment and situation (e.g., the trained neural network is fed inputs including sets of human factors and a query to predict how a virtual human will behave). Analysis module 516 may perform analysis on the work production, work safety, and ergonomic scores to develop optimized work station configuration and/or plant setup.

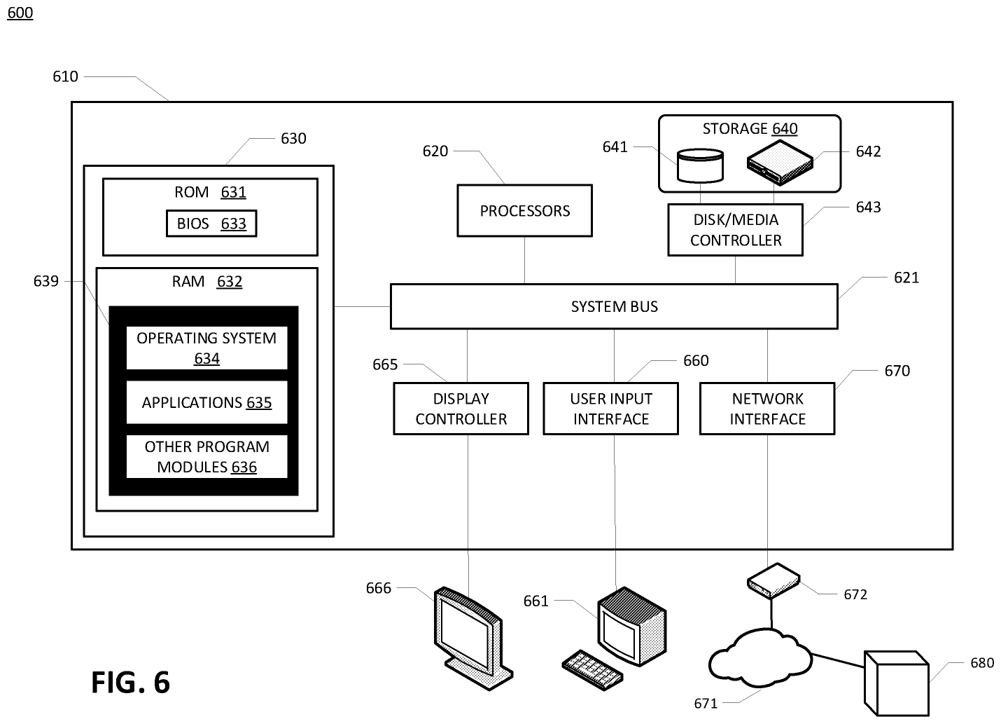

FIG. 6 shows an exemplary computing environment within which embodiments of the disclosure may be implemented. A computer system 610 is shown, which may be implemented as an HMI unit or other type of control system device for industrial automation as described above. As shown in FIG. 6, the computer system 610 may include a communication mechanism such as a system bus 621 or other communication mechanism for communicating information within the computer system 610. The computer system 610 further includes one or more processors 620 coupled with the system bus 621 for processing the information.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. As shown, software stack 639 may include operating system 634, containerized applications 635, and other program modules 636.

The operating system 634 may be loaded into the memory 630, being retrieved from storage 640, and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of program modules 636, or other program modules (not shown) being stored in the data storage 640. The operating system 634 may include any operating system now known or which may be developed in the future including, but not limited to, any server operating system, any mainframe operating system, or any other proprietary or non-proprietary operating system.

The applications 635 may include a set of computer-executable instructions for performing the neural network training and operation as previously described. Each of the applications 635 may run independently and may be interfaced with others of the applications 635 in accordance with embodiments of the disclosure.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid-state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610, and may be used to store image processing data in accordance with the embodiments of the disclosure.

The computer system 610 may also include a display controller 665 coupled to the system bus 621 to control a display or monitor 666, such as a cathode ray tube (CRT) or liquid crystal display (LCD), for displaying information to a computer user. The computer system 610 includes a user input interface 660 and one or more input devices, such as a user terminal 661, which may include a keyboard, touchscreen, tablet and/or a pointing device, for interacting with a computer user and providing information to the processors 620. The user terminal 661 may provide a touch screen interface. Display 666 and/or user terminal 661 may be disposed as a separate device, or as part of a single self-contained unit that encloses the computer system 610.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as the magnetic hard disk 641 or the removable media drive 642. The magnetic hard disk 641 may contain one or more data stores and data files used by embodiments of the present invention. The data store may include, but are not limited to, databases (e.g., relational, object-oriented, etc.), file systems, flat files, distributed data stores in which data is stored on more than one node of a computer network, peer-to-peer network data stores, or the like. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, an embedded Edge device, a web-based server, a gateway, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f), unless the element is expressly recited using the phrase “means for.”

What is claimed is:

1. A system for modeling human behavior, comprising:
a processor; and
a computer readable medium having stored thereon a set of modules executable by the processor, the modules comprising:
a classification module configured to receive sensor data from one or more sensors monitoring human behavior associated with a work task and to identify the type of human behavior based on a trained neural network;
a prediction module configured to receive the identified type of human behavior from the classifier and to generate prediction data representing predicted next one or more human actions based on a time series of position vectors learned by the trained neural network; and
a rendering module for translating the prediction data into a visual rendering for a virtual human simulation model.

2. The system of claim 1, wherein the position vectors of the trained neural network represents elements of human body positions in a time sequence.

3. The system of claim 1, wherein the position vectors include environmental parameters and situation parameters associated with the monitored human activity.

4. The system of claim 1, wherein the position vectors include data fields for gender, body size, and experience for the monitored work task.

5. The system of claim 1, further comprising:
an alert module configured to signal an alert based on the prediction data in response to determining that next one or more human actions is likely to produce a human injury or damage to work equipment.

6. The system of claim 1, further comprising:
an analysis module configured to rank predicted behavior states of work production, work safety, ergonomic scores, or a combination thereof using the trained neural network tuned to simulated environment and situation parameters so that parameter weights correspond to a new problem having a proposed environment and situation, wherein the trained neural network is fed inputs including sets of human factors and a query to predict how a virtual human will behave.

7. The system of claim 6, wherein the analysis module is further configured to perform analysis of the ranked scores to develop an optimized work station configuration.

8. A computer-based method for modeling human behavior, comprising:
receiving, by a classification module, sensor data from one or more sensors monitoring human behavior associated with a work task and to identify the type of human behavior based on a trained neural network;
receiving, by a prediction module, the identified type of human behavior from the classifier and to generate prediction data representing predicted next one or more human actions based on a time series of position vectors learned by the trained neural network; and
translating, by a rendering module, the prediction data into a visual rendering for a virtual human simulation model.

9. The method of claim 8, wherein the position vectors of the trained neural network represents elements of human body positions in a time sequence.

10. The method of claim 8, wherein the position vectors include environmental parameters and situation parameters associated with the monitored human activity.

11. The method of claim 8, wherein the position vectors include data fields for gender, body size, and experience for the monitored work task.

12. The method of claim 8, further comprising:
signaling, by an alert module, an alert based on the prediction data in response to determining that next one or more human actions is likely to produce a human injury or damage to work equipment.

13. The method of claim 8, further comprising:
ranking, by an analysis module, predicted behavior states of work production, work safety, ergonomic scores, or a combination thereof using the trained neural network tuned to simulated environment and situation parameters so that parameter weights correspond to a new problem having a proposed environment and situation, wherein the trained neural network is fed inputs including sets of human factors and a query to predict how a virtual human will behave.

14. The method of claim 13, further comprising:
performing, by the analysis module, analysis of the ranked scores to develop an optimized work station configuration.

15. The method of claim 8, wherein the neural network is trained using machine state and environmental condition data collected by various sensors, wherein the neural network training includes deriving a situational awareness driven model by annotating predicted situations based on similarity of complexity and dynamics between known and unknown situations.
